(19) United States
(12) Patent Application Publication
(10) Pub. No.: US 2009/0097245 A1
(43) Pub. Date: Apr. 16, 2009

(54) PRISM SHEET AND BACKLIGHT MODULE USING THE SAME

(75) Inventors: TUNG-MING HSU, Tu-Cheng (TW); SHAO-HAN CHANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/957,493

(22) Filed: Dec. 17, 2007

(30) Foreign Application Priority Data
Oct. 12, 2007 (CN) 200710202039.1

(51) Int. Cl. F21V 5/02; G02B 5/04

(52) U.S. Cl. 362/235; 359/837

(57) ABSTRACT

An exemplary prism sheet includes a transparent main body. The main body includes a first surface, a second surface opposite to the first surface, a plurality of micro-depressions formed in the first surface, a plurality of spherical micro-protrusions formed in the second surface. Each micro-depression is defined by four connecting inner sidewalls. A transverse width of each inner sidewall of each micro-depression progressively decreases with increasing distance from its bottom surface that is coplanar with the first surface of the transparent main body. A backlight module using the present prism sheet is also provided.

### CROSS-REFERENCE TO RELATED APPLICATIONS

This application is related to nine co-pending U.S. patent applications, which are: application Ser. No. 11/938,307 and Ser. No. 11/938,308, filed on Nov. 12, 2007, and both entitled “PRISM SHEET AND BACKLIGHT MODULE USING THE SAME”; application Ser. No. 11/940,328, filed on Nov. 15, 2007, and entitled “PRISM SHEET AND BACKLIGHT MODULE USING THE SAME”, application Ser. No. 11/946,866 and Ser. No. 11/946,867, filed on Nov. 12, 2007, and both entitled “PRISM SHEET AND BACKLIGHT MODULE USING THE SAME”, application Ser. No. 11/949,058, Ser. No. 11/949,059 and Ser. No. 11/949,060, filed on Dec. 3, 2007, and both entitled “PRISM SHEET AND BACKLIGHT MODULE USING THE SAME”, and application serial no. [to be determined], with Attorney Docket No. US16427, entitled “PRISM SHEET AND BACKLIGHT MODULE USING THE SAME”. In all the co-pending applications, the inventors are Tung-Ming Hsu and Shao-Han Chang. The co-pending applications have the same assignee as the present application. The disclosure of the above identified application is incorporated herein by reference.

### BACKGROUND OF THE INVENTION

1. Field of the Invention

The present invention relates to prism sheets, and particularly, to a prism sheet used in a backlight module.

2. Discussion of the Related Art

In a liquid crystal display device (LCD device), liquid crystal is a substance that does not illuminate light by itself. Instead, the liquid crystal propagates light received from a light source to display information. In the case of a typical liquid crystal display device, a backlight module powered by electricity supplies the needed light.

FIG. 8 depicts a typical direct type backlight module 100. The backlight module 100 includes a housing 11, a plurality of lamps 12 disposed above a base of the housing 11, a light diffusion plate 13, and a prism sheet 10 stacked on top of the housing 11 in that order. Inner walls of the housing 11 are configured for reflecting certain light upwards. The light diffusion plate 13 includes a plurality of dispersion particles (not shown). The dispersion particles are configured for scattering light, thus enhancing the uniformity of light output from the light diffusion plate 13.

Referring to FIG. 9, the prism sheet 10 includes a base layer 101 and a prism layer 103 formed on the base layer 101. The prism layer 103 contains a plurality of parallel prism lenses 105 having a triangular cross section. The prism lenses 105 are configured for collimating received light to a certain extent. Typically, a method of manufacturing the prism sheet 10 includes the following steps: first, a melted ultraviolet (UV)-cured transparent resin is coated on the base layer 101, then the melted UV-cured transparent resin is solidified into the prism lenses 105.

In use, unscattered light from the lamps 12 enters the light diffusion plate 13 and becomes scattered. The scattered light leaves the light diffusion plate 13 and enters the prism sheet 10. The scattered light then travels through the prism sheet 10 before refracting out at the prism lenses 105 of the prism layer 103. Thus, refracted light that leaves the prism sheet 10 is concentrated at the prism layer 103 and increases the brightness (illumination) of the prism sheet 10. The refracted light then propagates into an LCD panel (not shown) disposed above the prism sheet 10.

When the light is scattered in the light diffusion plate 13, scattered light enters the prism sheet at different angles of incidence. Referring to FIG. 10, when scattered light enters the prism sheet 10 at different angles of incidence, the scattered light generally travels through the prism sheet 10 along three light paths. In the first light path (such as a₁, a₂) the light enters the prism sheet at small angles of incidence and refracts out of the prism lenses with the refracted path closer to the normal to the surface of the base layer. In the second light path (such as a₃, a₄) the light enters the prism sheet 10 at angles of incidence larger than the first light path and refracts out of the prism lenses 105 with the refracted path being closer to normal to the surface of the prism lenses 105. Both the first light path and the second light path contribute to the light utilization efficiency of the backlight module 100. However, in a case of the third light path (such as a₅, a₆), the light enters the prism sheets at angles greater than the second light path, such that when the refracted light traveling in the third light path leaves the prism sheet 10 at the prism lenses 105 the refracted light impinges on the surface of adjacent prism lens 105 and reenters the prism sheet 10. Thus, light traveling along the third light path will eventually reenter the prism sheet 10 and may exit the prism sheet 10 on the same side the light entered. The third light path does not contribute to the light utilization efficiency of the backlight module 100. Further, the third light path may interfere with or inhibit other incident light resulting in decreasing brightness of the backlight module 100.

What is needed, therefore, is a new prism sheet and a backlight module using the prism sheet that can overcome the above-mentioned shortcomings.

### SUMMARY

In one aspect, a prism sheet according to a preferred embodiment includes a transparent main body. The main body includes a first surface, a second surface opposite to the first surface, a plurality of micro-depressions formed in the first surface, a plurality of spherical micro-protrusions formed in the second surface. Each micro-depression is defined by four connecting inner sidewalls. A transverse width of each inner sidewall of each micro-depression progressively decreases with increasing distance from its bottom surface that is coplanar with the first surface of the transparent main body.

In another aspect, a backlight module according to a preferred embodiment includes a plurality of lamps, a light diffusion plate and a prism sheet. The light diffusion plate is disposed above the lamps and the prism sheet is stacked on the light diffusion plate. The prism sheet is same as described in a previous paragraph.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present prism sheet and backlight module. Moreover, in the drawings, like reference numerals designate corresponding parts throughout several views, and all the views are schematic.

FIG. 1 is a side, cross-sectional view of a backlight module using a prism sheet according to a first preferred embodiment of the present invention.

FIG. 2 is a bottom plan view of the prism sheet of FIG. 1.

FIG. 3 is an isometric view of the prism sheet of FIG. 1.

FIG. 4 is a bottom plan view of a prism sheet according to a second preferred embodiment of the present invention.

FIG. 5 is a bottom plan view of a prism sheet according to a third preferred embodiment of the present invention.

FIG. 6 is a bottom plan view of a prism sheet according to a fourth preferred embodiment of the present invention.

FIG. 7 is a top plan view of a prism sheet according to a fifth preferred embodiment of the present invention.

FIG. 8 is a side cross-sectional view of a conventional backlight module employing a typical prism sheet.

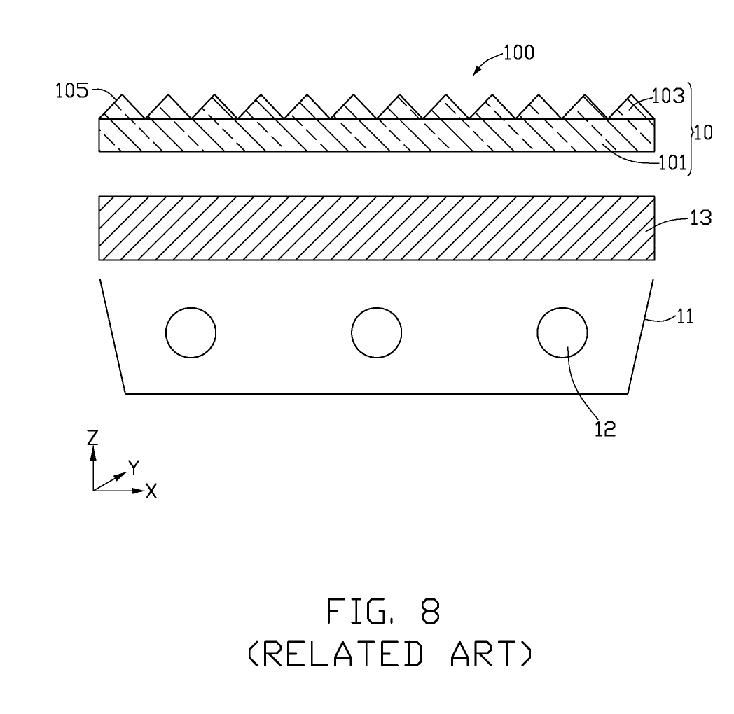

FIG. 9 is an isometric view of the prism sheet shown in FIG. 8.

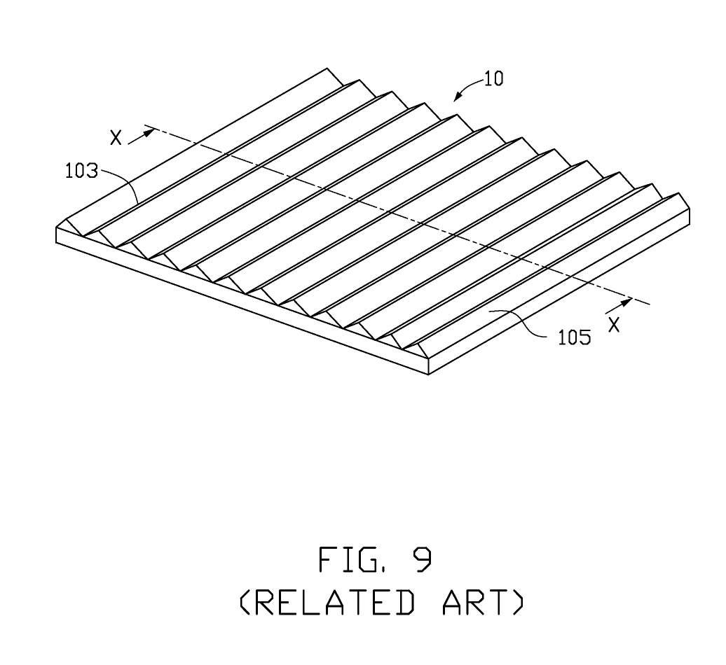

FIG. 10 is side, cross-sectional view of the prism sheet of FIG. 9, taken along line X-X, showing light transmission paths.

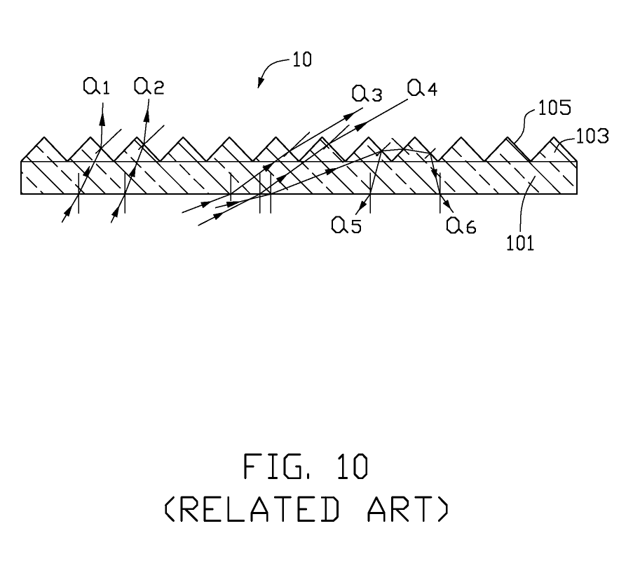

### DETAILED DESCRIPTION OF THE PREFERRED EMBODIMENTS

Reference will now be made to the drawings to describe preferred embodiments of the present prism sheet and backlight module, in detail.

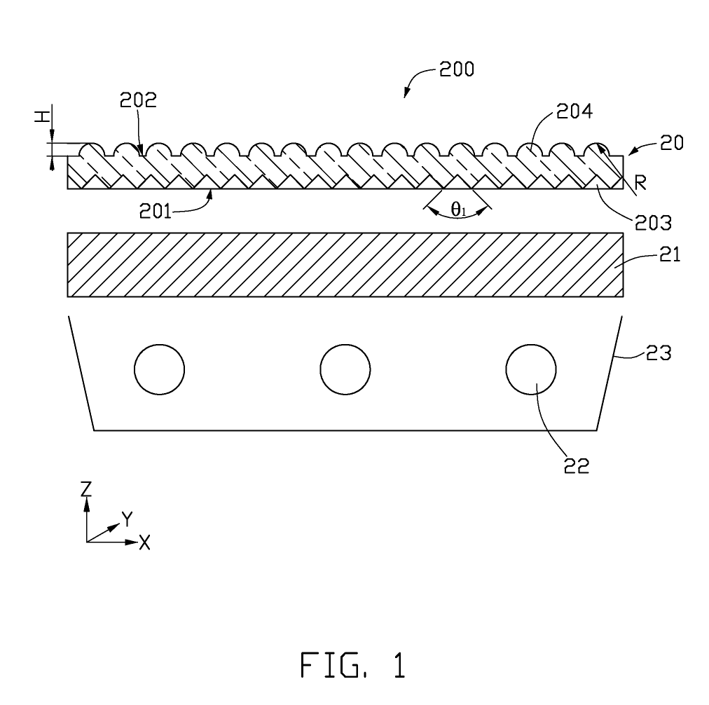

Referring to FIG. 1, a backlight module 200 in accordance with a first preferred embodiment of the present invention is shown. The backlight module 200 includes a prism sheet 20, a light diffusion plate 21, a plurality of lamps 22, and a housing 23. The lamps 22 are regularly aligned above a base of the housing 23. The light diffusion plate 21 and the prism sheet 20 are stacked on the top of the housing 23 in that order.

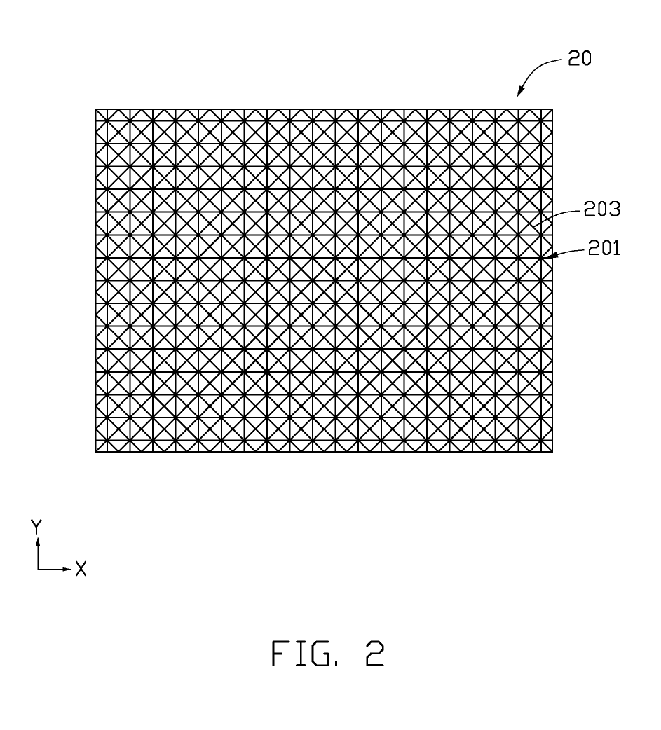

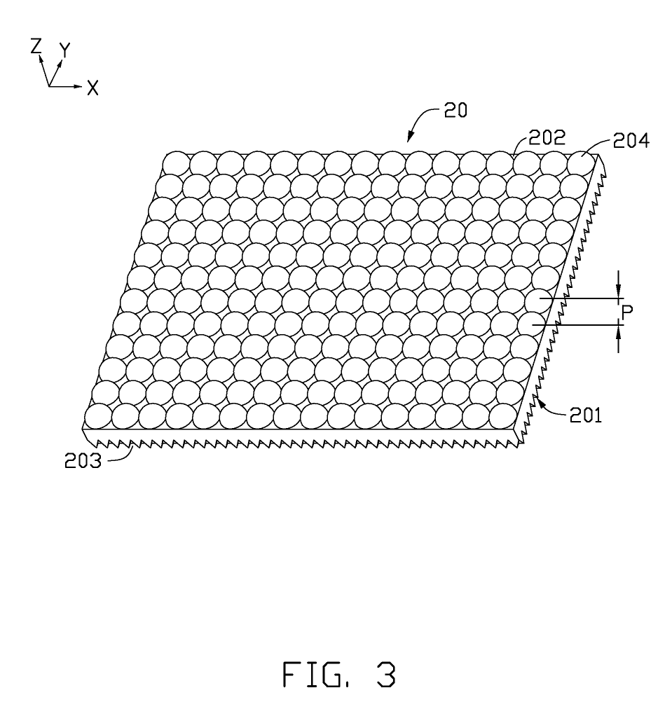

Referring to FIGS. 2 and 3, the prism sheet 20 includes a transparent main body. The main body includes a first surface 201 and a second surface 202. The first surface 201 and the second surface 202 are on opposite sides of the main body. Furthermore, the first surface 201 and the second surface 202 defines a plurality of micro-depressions 203 and a plurality of spherical micro-protrusions 204 respectively. The prism sheet 20 is stacked on the light diffusion plate 21 in a way such that the first surface 201 is adjacent to the light diffusion plate 21, and the second surface 202 is away from the light diffusion plate 21. Each micro-depression 203 has a shape like an inverted prism and is enclosed by four triangular inner sidewalls connected with each other. In the first preferred embodiment, each first micro-depression 203 is a square pyramidal void formed by four triangular sidewalls. The triangular inner sidewalls are isosceles triangles. A transverse width of each of the triangular inner sidewalls progressively decreases with increasing distance from the first surface 201.

In the first embodiment, the micro-depressions 203 are formed side by side on the first surface 201 according to a first matrix manner. The micro-depressions 203 are configured for enabling the first surface 201 to converge incident light from the lamps 22 to a certain extent (hereafter first light convergence). Rows and columns of the micro-depressions 203 in the matrix are parallel to the edges of the prism sheet 20 (along an X-axis and a Y-axis direction) correspondingly. A pitch between adjacent micro-depressions 203 along either the X-axis direction or the Y-axis direction is configured to be in the range from about 0.025 millimeters to about 1 millimeter. Again referring to FIG. 1, a dihedral angle θ₁, defined between the sidewalls on opposite sides of each micro-depression 203 is configured to be in the range from about 40 degrees to about 120 degrees. In the alternative embodiment, rows or columns, of the first micro-depressions 203, may be obliquely aligned to the sides of the prism sheet, thus having other alignments or orientations.

In a first preferred embodiment, the spherical micro-protrusions 204 are arranged regularly on the second surface 202 in a matrix. Each spherical micro-protrusion is substantially a hemisphere. The spherical micro-protrusions 204 are configured for enabling the second surface 202 to converge light emitting the second surface 202 (hereafter second light convergence).

In order to obtain a better optical effect, A distance P between centers of adjacent spherical micro-protrusions 204 is in the range from about 0.025 millimeters to 1.5 millimeters. A radius R of each spherical micro-protrusion 204 is in the range from about a quarter of the distance P to about double the distance P. A maximum height H of the spherical micro-protrusions 204 relative to the second surface 202 is in the range from about 0.01 millimeters to the radius R. In the first embodiment, the height H is equal to the radius R, and the distance P is equal to double the radius R. It can be understood that each spherical micro-protrusion 204 can be replaced by a similar micro-protrusion that is smaller than a hemisphere. That is, each spherical protrusion 204 can instead of a sub-hemispherical protrusion.

A thickness of the prism sheet 20 is preferably in the range from about 0.5 millimeters to about 3 millimeters. The prism sheet 20 can be made of transparent material selected from the group consisting of polycarbonate (PC), polymethyl methacrylate (PMMA), polystyrene (PS), copolymer of methylmethacrylate and styrene (MS), and any suitable combination thereof.

Again referring to FIG. 1, the lamps 22 can be point light sources such as light emitting diodes or linear light sources such as cold cathode fluorescent lamps. Even though the housing 23 is made of high reflectivity material, additionally, an extra coating can be further applied on the interior. In this embodiment, the lamps 22 are cold cathode fluorescent lamps. The housing 23 is made of high reflective metal.

In the backlight module 200, when the light enter the prism sheet 20 via the first surface 201, the light undergoes the first light convergence at the first surface 201. Then the light further undergoes a second light convergence at the second surface 202 before exiting the prism sheet 20. Thus, a brightness of the backlight module 200 is increased. In addition, due to the micro-depressions 203, the light exiting the prism sheet 20 would mostly propagate along directions substantially parallel to the Z-direction. At the same time, less light would travel along directions parallel to the X-direction, minimizing light energy loss. Thus, the light energy utilization rate of the backlight module 200 is high.

When compared with the conventional prism sheet, the prism sheet 20 is easier to mass produce because the prism lenses of the conventional prism sheet is manufactured by solidifying melted ultraviolet-cured transparent resin whereas the prism sheet 20 is manufactured by injection molding. The prism lenses made by ultraviolet-cured transparent resin are usually damaged or scratched due to poor rigidity, mechanical strength, and the abrasive properties of the transparent resin. However, the prism sheet 20 of the present invention has better rigidity, mechanical strength, and abrasive properties. Therefore, the present prism sheet is not easily damaged or scratched.

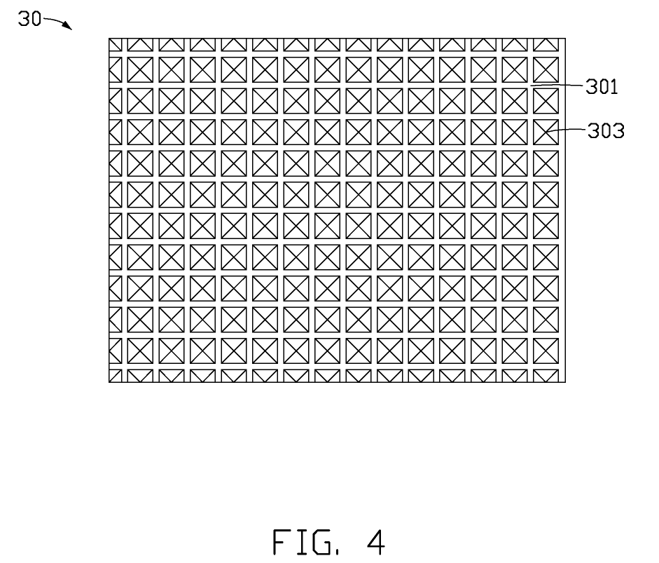

Referring to FIG. 4, a prism sheet 30 in accordance with a second preferred embodiment of the present invention is shown. The prism sheet 30 is similar in principle to the prism sheet 20. However, micro-depressions 303 are aligned apart on first surface 301 of the prism sheet 30 in a matrix arrangement.

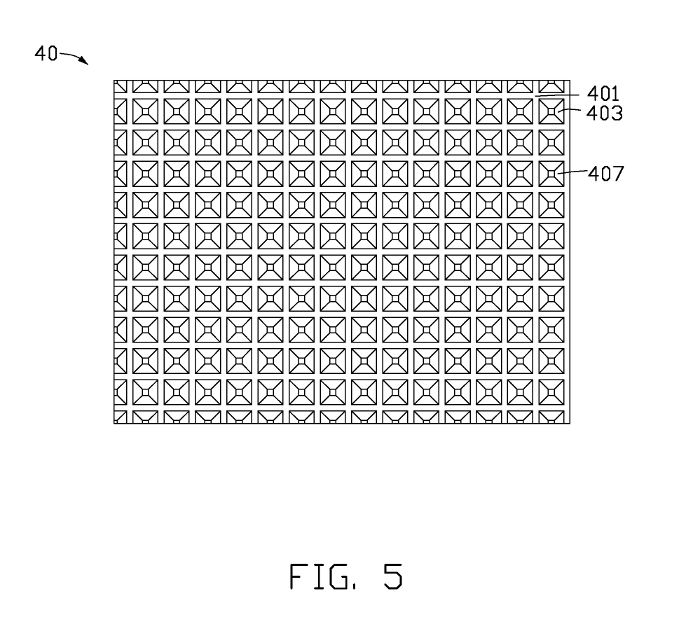

Referring to FIG. 5, a prism sheet 40 in accordance with a third preferred embodiment of the present invention is shown. The prism sheet 40 is similar in principle to the prism sheet 30, except that each of first micro-depressions 403 of first surface 401 is a frusto-pyramidal depression, and includes four inner sidewalls 407. Each of the inner sidewalls 407 of the first micro-depressions 403 is an isosceles trapezium.

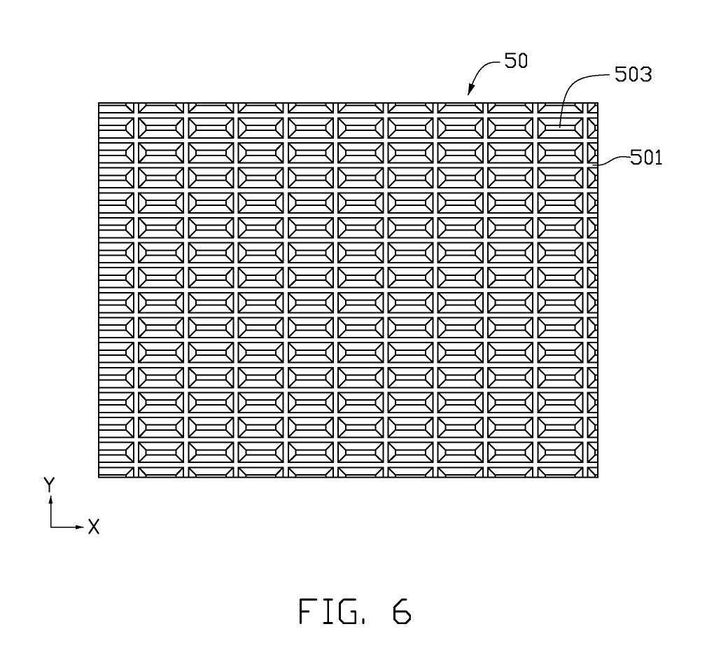

Referring to FIG. 6, a prism sheet 50 according to a fourth embodiment is shown. The prism sheet 50 is similar in principle to the prism sheet 30, except that each of micro-depressions 503 of a first surface 501 is a polyhedron depression that includes four inner sidewalls. A first pair of opposite inner sidewalls of the four inner sidewalls is isosceles triangles with planar surfaces parallel to an X-axis. A second pair of opposite inner sidewalls of the four inner sidewalls is isosceles trapeziums with planar surfaces parallel to a Y-axis.

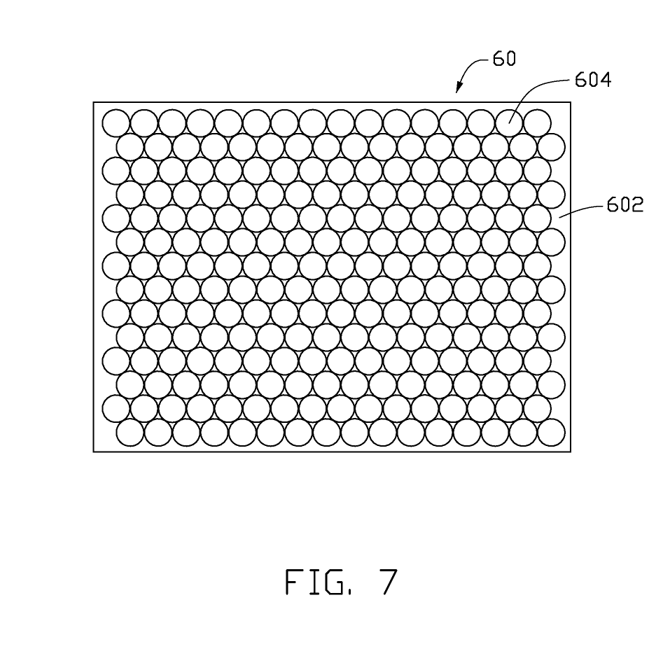

Referring to FIG. 7, a prism sheet 60 according to a fifth embodiment is shown. The prism sheet 60 is similar in principle to the prism sheet 20, except that spherical micro-protrusions 604 of a second surface 602 are aligned side by side in a matrix manner.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. A prism sheet comprising:
a transparent main body having:
a first surface,
a second surface opposite to the first surface,
a plurality of micro-depressions formed in the first surface and a plurality of spherical micro-protrusions formed in the second surface, wherein each of the micro-depressions is defined by four connecting inner sidewalls; a transverse width of each inner sidewall progressively decreases with increasing distance from its bottom surface that is coplanar with the first surface of the transparent main body.

2. The prism sheet according to claim 1, wherein a pitch of the adjacent spherical micro-protrusions is in the range from about 0.025 millimeters to about 1.5 millimeters.

3. The prism sheet according to claim 1, wherein a radius of each spherical micro-protrusion is in the range from about 0.01 millimeters to about 1.5 millimeters, and a maximum height of each spherical micro-protrusion being configured to be in the range from 0.01 millimeters to the radius of each spherical micro-protrusion.

4. The prism sheet according to claim 1, wherein the micro-depressions and the second micro-depressions are selected from a group consisting of rectangular pyramidal depression and frusto-pyramidal depression.

5. The prism sheet according to claim 1, wherein a dihedral angle defined between two opposite sidewalls of each micro-depression is configured to be in a range from about 40 degrees to about 120 degrees.

6. The prism sheet according to claim 1, wherein a pitch of the adjacent micro-depressions is configured to be in a range from about 0.025 millimeters to about 1 millimeter.

7. The prism sheet according to claim 1, wherein a thickness of the prism sheet is in a range from about 0.5 millimeters to about 3 millimeters.

8. The prism sheet according to claim 1, wherein the micro-depressions and the spherical micro-protrusions are distributed in a matrix manner.

9. The prism sheet according to claim 8, wherein rows or columns of the micro-depressions are parallel or slanted to the respective edges of the prism sheet.

10. The prism sheet according to claim 1, wherein the micro-depressions are aligned apart on the first surface.

11. The prism sheet according to claim 1, wherein the micro-depressions are aligned side by side on the first surface according to a matrix manner.

12. The prism sheet according to claim 1, wherein the spherical micro-protrusions are aligned side by side on the second surface according to a matrix manner.

13. The prism sheet according to claim 1, wherein the prism sheet is made of transparent material selected from the group consisting of polycarbonate, polymethyl methacrylate, polystyrene, copolymer of methylmethacrylate and styrene, and any combination thereof.

14. A backlight module comprising:
a plurality of lamps;
a light diffusion plate disposed above the lamps; and
a prism sheet disposed on the light diffusion plate, the prism sheet including a transparent main body having
a first surface,
a second surface opposite to the first surface, and
a plurality of micro-depressions formed in the first surface and a plurality of spherical micro-protrusions formed in the second surface, wherein each of the micro-depressions is defined by four connecting inner sidewalls; a transverse width of each inner sidewall progressively decreases with increasing distance from its bottom surface that is coplanar with the first surface of the transparent main body.

15. The backlight module according to claim 14, wherein the micro-depressions are selected from a group consisting of rectangular pyramidal depression and frusto-pyramidal depression.

16. The backlight module according to claim 14, wherein a dihedral angle defined between two opposite sidewalls of each micro-depression is configured to be in a range from about 40 degrees to about 120 degrees.

17. The backlight module according to claim 14, wherein a thickness of the prism sheet is in a range from about 0.5 millimeters to about 3 millimeters.

18. The backlight module according to claim 14, wherein the micro-depressions and the spherical micro-protrusions are distributed in a matrix manner.

19. The prism sheet according to claim 18, wherein rows or columns of the micro-depressions are parallel to or slanted to the respective edges of the prism sheet.

20. The backlight module according to claim 14, wherein spherical micro-protrusions are aligned side by side on the second surface according to a matrix manner.
